(19) United States
(12) Patent Application Publication
(10) Pub. No.: US 2022/0171948 A1
(43) Pub. Date: Jun. 2, 2022

(54) CARD ISSUING SYSTEM AND CARD PRINTING METHOD

(71) Applicant: NIDEC SANKYO CORPORATION, Nagano (JP)

(72) Inventor: Kyosuke KUBOTA, Nagano (JP)

(21) Appl. No.: 17/535,966

(22) Filed: Nov. 26, 2021

(30) Foreign Application Priority Data
Nov. 30, 2020 (JP) 2020-197910

(51) Int. Cl. G06K 1/12; G06F 3/12

(52) U.S. Cl. CPC G06K 1/121; G06F 3/121; G06F 3/1235

(57) ABSTRACT

A card issuing system includes a card issuing device that issues cards and a host device connected to the card issuing device. The host device includes an application executor to select card printing setting data corresponding to a state of the card issuing device, and a driver executor to transmit the card printing setting data selected by the application executor to the card issuing device. The card issuing device includes a setting acquirer to acquire the card printing setting data from the host device, and a printer to perform printing on the cards using the card printing setting data acquired by the setting acquirer.

### RELATED APPLICATIONS

The present application claims priority to Japanese Application Number 2020-197910, filed Nov. 30, 2020, the disclosure of which is hereby incorporated by reference herein in its entirety.

### BACKGROUND

### Field of the Invention

At least an embodiment of the present invention relates in particular to a card issuing system including a card issuing device for issuing cards, and a card printing method.

### Description of the Related Documents

In general, card issuing systems for issuing a card-like recording medium (hereinafter simply referred to as a “card”) have been used.

Such a card issuing system is configured such that a card issuing device that issues cards is connected to a host device, such as an automated teller machine (ATM). Such a card issuing device often includes a printing section, such as a printer, that performs printing on cards, where the cards are stacked and accommodated before issuance.

As an example of such a general printing section, Japanese Unexamined Patent Application Publication No. 2019-188708 discloses a printing section of a thermal transfer type having a thermal head that heats an ink ribbon to transfer ink applied to the ink ribbon to a card for printing.

In such a general printing section, setting data for printing, such as data on a timing for melting an ink ribbon, is stored in a built-in recording medium.

Here, in recent years, card issuing systems have been required to perform printing using various types of card and ink ribbons.

However, storage capacity of a recording medium in the printing section is limited, and therefore, all appropriate setting data for various types of card, ink ribbons, and other consumables may not be stored. Therefore, when printing is performed using cards or ink ribbons that are not suitable for specified setting data, a desired printing state may not be attained.

At least an embodiment of the present invention is made in view of such a situation, and it is an object of at least an embodiment of the present invention to provide a card issuing system capable of solving the above-described problems and appropriately performing printing using various types of card and consumables without storing a large amount of setting data in a printing section.

### SUMMARY

According to at least an embodiment of the present invention, a card issuing system includes a card issuing device that issues cards and a host device connected to the card issuing device. The host device includes an application executor to select card printing setting data corresponding to a state of the card issuing device, and a driver executor to transmit the card printing setting data selected by the application executor to the card issuing device. The card issuing device includes a setting acquirer to acquire the card printing setting data from the host device, and a printer to perform printing on the cards using the card printing setting data acquired by the setting acquirer.

With this configuration, printing may be appropriately performed on the various types of card using the consumables.

In the card issuing system according to at least the embodiment of the present invention, the card printing setting data may include a setting value for appropriate printing based on a state of consumables for printing.

With this configuration, various states of consumables may be supported.

In the card issuing system according to at least the embodiment of the present invention, the consumables may include an ink ribbon for printing on the cards, and a state of the card issuing device may include at least a type of the cards to be printed by the printer or a state of the ink ribbon mounted on the printer.

With this configuration, various types of ink ribbon may be supported.

In the card issuing system according to at least the embodiment of the present invention, the setting value may include a strobe value that is a value of a timing when a print head used for printing using the ink ribbon is operated.

With this configuration, printing may be performed with desired quality even with a special ink ribbon.

In the card issuing system according to at least the embodiment of the present invention, the card issuing device may further include a consumable information acquirer to acquire information on the consumables, and the application executor determines a state of the card issuing device based on the information on the consumables acquired by the consumable information acquirer.

With this configuration, the appropriate card printing setting data may be selected without specifying the card printing setting data in the application execution section.

According to at least another embodiment of the present invention, a card issuing method is executed by a card issuing system including a card issuing device that issues cards and a host device connected to the card issuing device. The card issuing method includes selecting, by the host device, card printing setting data corresponding to a state of the card issuing device, transmitting, by the host device, the selected card printing setting data to the card issuing device, acquiring, by the card issuing device, the card printing setting data from the host device, and performing, by the card issuing device, printing on the cards using the acquired card printing setting data.

With this configuration, printing may be appropriately performed on the various types of card using the consumables.

According to at least an embodiment of the present invention, a card issuing system configured such that the host device selects the card printing setting data corresponding to a state of the card issuing device and the card issuing device acquires and print the card printing setting data so that appropriate printing is performed using various types of card and various types of consumables may be provided.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a diagram illustrating a system configuration of a card issuing system according to at least an embodiment of the present invention;

FIG. 2 is a flowchart of a card printing setting process according to at least the embodiment of the present invention;

FIG. 3 is a diagram illustrating an example of a screen of card printing setting data in the card printing setting process shown in FIG. 2;

FIG. 4 is a diagram illustrating a system configuration of a card issuing system according to at least another embodiment of the present invention; and

FIG. 5 is a flowchart of a card printing setting process according to at least the other embodiment of the present invention.

### DETAILED DESCRIPTION

### Embodiments

### Configuration of Card Issuing System X

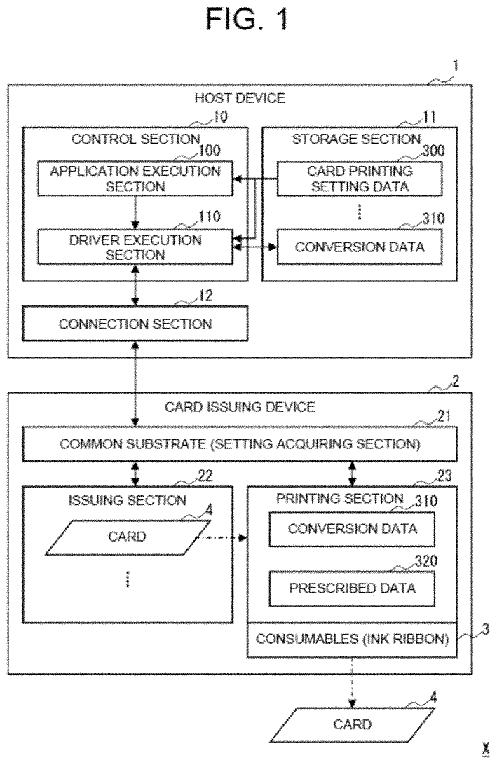

A configuration of a card issuing system X according to at least an embodiment of the present invention will be described with reference to FIG. 1. The card issuing system X is a device for newly issuing a card 4. Examples of the card issuing system X include ATMs having a card issuing function, terminals in Kiosk, ticket issuing systems of transportation systems, point card issuing systems of convenience stores or the like, member card issuing systems of retail stores, card issuing payment systems of amusement machines, and entrance/exit management systems (hereinafter simply referred to as “ATMs, etc.”).

Specifically, the card issuing system X includes a host device 1 and a card issuing device 2. In this embodiment, the host device 1 and the card issuing device 2 are connected to each other through a universal serial bus (USB) or the like.

The host device 1 is, in this embodiment, an information processing device for controlling the card issuing device 2 and realizing functions of ATMs, etc. Specifically, the host device 1 is a main body device, such as an ATM, etc., and includes a control computing device, such as a personal computer (PC), a tablet terminal, or a cellular phone for control. Specifically, the host device 1 executes application software (hereinafter simply abbreviated to “application”) for realizing the functions of the card issuing system X. In this embodiment, the host device 1 is connected to the card issuing device 2 to be controlled. In addition to this, the host device 1 may also be connected to a network, various peripheral devices, and the like.

The card issuing device 2 is a print-issuing printer, a card reader, or the like that issues a card 4 after printing required information on the card 4 in accordance with instructions issued by the host device 1. In this embodiment, communication between the card issuing device 2 and the host device 1 is performed, for example, by a USB cable connected therebetween.

The card 4 supported by the card issuing system X of this embodiment is a contactless IC card, a contact IC card, and/or a magnetic card equipped with a magnetic stripe. The card 4 has a rectangular shape having a thickness of approximately 0.7 mm to approximately 0.8 mm and is made of vinyl chloride, for example. When the card 4 is a magnetic card, for example, a magnetic stripe is formed in which magnetic data is recorded. When the card 4 is a contactless IC card and/or a contact IC card, for example, an IC chip is built in. Here, both an IC chip and a magnetic stripe may be included in the card 4. Furthermore, when the card 4 is a contactless IC card, the card 4 may have a built-in read/write (R/W) antenna for near-field communication.

Note that the card 4 may be a polyethylene terephthalate (PET) card having a thickness of approximately 0.18 mm to approximately 0.36 mm, a paper card of a predetermined thickness, or the like.

The consumables 3 for the card issuing system X of this embodiment represent, for example, an ink ribbon for the printing section 23 described below. The ink ribbon is, for example, a sublimation or thermal transfer ink ribbon for printing in color or black and white on the card 4. Furthermore, in this embodiment, the ink ribbon may be a colored ink ribbon that includes yellow, magenta, cyan, and black films as provisions. The colored ink ribbons may further include an overcoat layer film to protect a printing surface. In addition, the ink ribbon may be of a black color only or a specialty (hereinafter referred to as a “special color”), such as an anti-counterfeit color with special metal particles or the like, a metallic color, a fluorescent color, or a hologram. In addition, the ink ribbon may be a multi-time ink ribbon (that can be used multiple times) or the like.

In this embodiment, an RFID tag (hereinafter referred to as a “wireless tag”) of a communication method (ISO 14443) similar to a method for contactless IC cards may be attached to the consumables 3 and may be used to manage consumable information including a type, an ID, a serial number, and the like of the consumables 3.

### System Configuration of Host Device 1

The host device 1 specifically includes a control section 10, a storage section 11, and a connection section 12.

The control section 10 is a control arithmetic section including a central processing unit (CPU), a micro processing unit (MPU), a graphics processing unit (GPU), a digital signal processor (DSP), and an application specific integrated circuit (ASIC).

The storage section 11 is a random access memory (RAM), a read only memory (ROM) including a flash memory or another non-volatile semiconductor memory, a magnetic recording medium, such as a solid state drive (SSD) or a hard disk drive (HDD), an optical recording medium, such as an optical disk, or another non-transitory recording medium.

The connection section 12 is a circuit and a physical interface, such as a chipset and an input/output (I/O) for connection to external devices. The connection section 12 includes a general-purpose serial interface, such as a USB, a parallel interface, and a digital video interface, for connection to the card issuing device 2. Furthermore, the connection section 12 includes a physical layer of a network interface for connection to a network.

In this embodiment, an example of connection between the connection section 12 to the card issuing device 2 via the USB is described. In addition, the connection section 12 is also used for connection to peripheral devices including a display, such as a liquid crystal display (LCD) panel or an organic electroluminescence (EL) panel, a touch panel, and various buttons provided in ATMs, etc.

### System Configuration of Card Issuing Device 2

The card issuing device 2 includes sections, such as a common substrate 21, an issuing section 22, and a printing section 23.

The common substrate 21 is a device for connecting the issuing section 22 and the printing section 23 to the host device 1. In this embodiment, the common substrate 21 is, for example, a circuit of a USB substrate disposed on a substrate of the card issuing device 2 and an interface. The common substrate 21 including a control arithmetic section, such as a CPU or an MPU, and a circuit of a USB hub, is connected to the issuing section 22 and the printing section 23 via the hub.

Specifically, the common substrate 21 is capable of receiving commands (instructions) issued from the host device 1 and transmitting responses (responding) to the commands via a USB cable.

The issuing section 22 is a hopper unit or the like that accommodates a new card 4 that has not been issued. The issuing section 22 is capable of discharging the accommodated card 4 along an internal conveying path to the printing section 23 under control of the host device 1.

The printing section 23 is a card printer having a function of frameless printing, a function of duplex printing, a function of color printing, and the like performed on the new card 4. The printing section 23 is a thermal transfer printer or a sublimation printer, and is capable of printing images of photograph quality and characters. Specifically, the printing section 23 including a circuit and a mechanism of a print head, such as a thermal head, prints a specified full-color bitmap image in several hundreds dpi. The thermal head is a heater array or the like that melts or sublimates ink included in an ink ribbon so as to fuse the ink on the card 4.

In this embodiment, the printing section 23 may further perform printing using a special ink ribbon of a metallic color, a fluorescent color, a hologram, or an overcoat, for example (hereinafter referred to as “special color printing”).

Furthermore, the printing section 23 includes a control section for performing control over conveyance and reading/writing of the card 4 in accordance with a received command, and a recording medium.

Among these, the control section is a control arithmetic section including a CPU, an MPU, a GPU, a DSP, or an ASIC that controls the sections included in the card issuing device 2. The control section further includes a non-transitory recording medium for storing a control program and various types of data including encrypted data. Although the recording medium includes, for example, a RAM and a ROM, a storage capacity of the recording medium may not be larger than that of the storage section 11 included in the host device 1.

Note that the card issuing device 2 may further have a function as a card reader capable of taking the card 4 inside the device by a motor drive and performing reading (read) or writing (write) on the card 4. In this case, the card issuing device 2 may perform reading/writing on an IC chip and reading/writing on a magnetic stripe, for example.

### Functional Configuration of Card Issuing System X

Next, a functional configuration for making settings of printing on the card 4 in the card issuing system X according to at least an embodiment of the present invention will be described.

The control section 10 of the host device 1 includes an application execution section 100 and a driver execution section 110.

The storage section 11 stores card printing setting data 300 and conversion data 310.

A recording medium of the printing section 23 of the card issuing device 2 stores the conversion data 310 and prescribed data 320.

The application execution section 100 is an application executor that executes an application that responds interactively to a user and sends various commands to the driver execution section 110. The application is, for example, an application of ATMs, etc. that performs various types of payment and the like and causes the card issuing device 2 to issue the card 4.

In this embodiment, the application execution section 100 selects the card printing setting data 300 corresponding to a state of the card issuing device 2. In this embodiment, the state of the card issuing device 2 may include, for example, at least one of a type of card 4 to be printed by the printing section 23 and a state of the ink ribbon which is the consumables 3 attached to the printing section 23.

The driver execution section 110 is a device control section that executes a device driver, middleware, and the like for controlling the card issuing device 2. The driver execution section 110 sends and receives commands and associated data to and from the card issuing device 2.

In this embodiment, the driver execution section 110 converts the card printing setting data 300 selected by the application executor into the conversion data 310 and transmits the conversion data 310 to the card issuing device 2.

In addition, the driver execution section 110 sends various commands when making a payment. Additionally, the driver execution section 110 may also transmit a card reading command for reading information stored in the card 4, a card writing command for writing information to the card 4, and the like.

In this embodiment, the common substrate 21 of the card issuing device 2 also functions as a setting acquirer.

The setting acquirer acquires the card printing setting data 300 from the host device 1 and transmits the card printing setting data 300 to the printing section 23.

In this embodiment, the printing section 23 stores the card printing setting data 300 acquired by the setting acquirer in an incorporated recording medium. The printing section 23 may then perform printing on the card 4 in accordance with the stored card printing setting data 300.

The card printing setting data 300 is setting data for printing on the card 4 including setting values for performing appropriate printing in accordance with a state of the consumables 3 for printing. Examples of the setting values include a print feed speed, a strobe value, a temperature compensation value, and an output gradation value. Of these setting values, the print feed speed represents a value of a card feed speed during printing, a value of a speed for advancing the ink ribbon, and the like. The strobe value is a value of a timing when a voltage is applied to the print head that uses the ink ribbon for printing to activate the print head. This strobe value enables adjustment of density in printing. Specifically, ease of heat transfer and a thickness of a film may differ for each color depending on the type of card 4 to be subjected to the printing and the type of ink ribbon. Therefore, adjustment may be performed in accordance with the strobe value. Furthermore, as the card printing setting data 300, for example, the respective values of strobe data of the color ribbon, strobe data of the black ribbon, strobe data of the overcoat ribbon, and the like, may be stored in this order, for example, in a unit of file.

The conversion data 310 is print setting data obtained by converting the card printing setting data 300 into a format usable by the card issuing device 2. The conversion data 310 is transmitted by the driver execution section 110 to the card issuing device 2 as data accompanying a command via the connection section 12, and is stored in the recording medium of the printing section 23. A plurality of conversion data 310 may be stored depending on storage capacity of the recording medium of the printing section 23. In this case, the conversion data 310 may be stored in the RAM or the flash memory of the recording medium of the printing section 23.

The prescribed data 320 is the print setting data for the default (prescribed) color ink ribbon installed in the printing section 23. The prescribed data 320 may have the same format (form) as the conversion data 310. The prescribed data 320 may be stored in the ROM or the flash memory of the recording medium of the printing section 23 at a time of factory shipment or shipment of the card issuing device 2.

Here, the control section 10 of the host device 1 functions as the application execution section 100 and the driver execution section 110 when executing the control program stored in the storage section 11.

Furthermore, each of the sections of the host device 1 and the card issuing device 2 serves as a hardware resource that executes a card reader control method of this embodiment.

Note that some of the above-described functional components or an arbitrary combination thereof may be configured as hardware by means of an IC, a programmable logic, a field-programmable gate array (FPGA), or the like.

### Card Printing Setting Process of Card Issuing System X

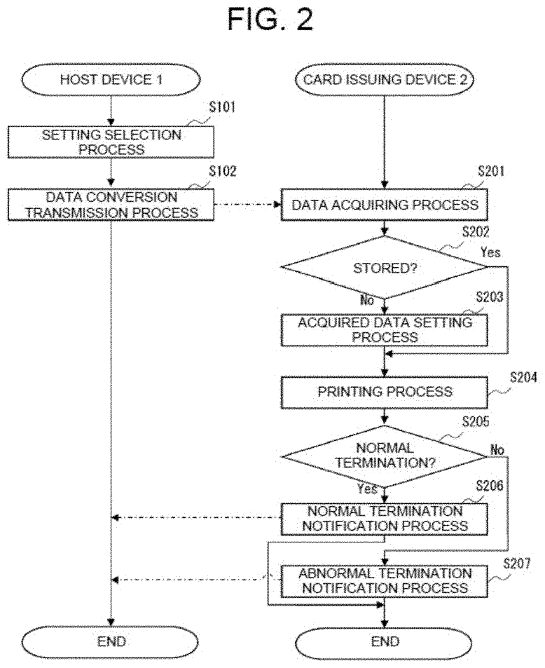

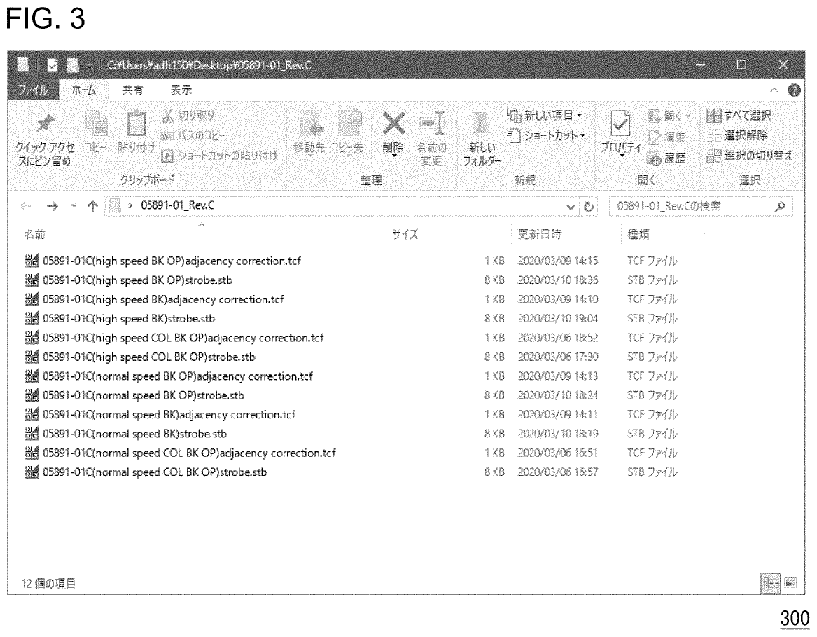

Next, a card printing setting process performed by the card issuing system X according to at least an embodiment of the present invention will be described with reference to FIGS. 2 and 3.

In the card printing setting process of this embodiment, an application of the ATMs, etc. is executed. At this time, card issuance is performed, and printing is performed on the card 4. Here, the host device 1 selects the card printing setting data 300 corresponding to a state of the card issuing device 2. The selected card printing setting data 300 is then transmitted to the card issuing device 2. The card issuing device 2 acquires the card printing setting data 300. Then, printing is performed on the card 4 in accordance with the acquired card printing setting data 300.

In the card printing setting process of this embodiment, the control section 10 executes the control program (not shown) stored in the storage section 11 in the host device 1 and controllers of the individual components execute the control program (not shown) stored in the recording medium in the card issuing device 2, in cooperation with the individual components using the hardware resources.

The card printing setting process of this embodiment will be described step by step in accordance with a flowchart of FIG. 2 below.

### Step S101

First, the application execution section 100 of the host device 1 performs a setting selection process.

Here, the application execution section 100 executes an application for performing card issuance and printing of ATMs, etc. This application may be executed when payment with the card 4, issuance of a loyalty card, or the like is performed.

Next, the application execution section 100 accepts an operation performed by a user, such as an operation on a touch panel or a numeric keypad, and selects the card printing setting data 300 corresponding to a state of the card issuing device 2 from among a plurality of types of card printing setting data 300 stored in the storage section 11 at a time of execution of printing processed by the application in the host device 1.

FIG. 3 is a diagram illustrating an example of a file list of the card printing setting data 300 corresponding to the state of the card issuing device 2. Among these files, a file, for example, for the color ink ribbon, includes settings for yellow, cyan, magenta, and black colors in the single setting file. Furthermore, the files may also include a setting for a special color and a setting for overcoat.

The application execution section 100 selects one or more files from these files, for example, when the consumables 3 represent an ink ribbon, depending on a type of card 4, a state of the ink ribbon, a speed of printing, and the like.

As the type of card 4, a normal card and a premium card, such as a gold card or a platinum card, may be discriminated from each other, for example. Alternatively, as the type of card 4, materials such as PVC, PET, paper, and metal, may be discriminated from one another. These types of card 4 may represent a type of card 4 in the hopper unit of the issuing section 22. Here, when there are a plurality of hopper units of the issuing section 22 that are selectable, the type of card 4 may represent a type of card 4 in one of the hopper units that is instructed to perform issuance by an application. Alternatively, the type of card 4 may be selected according to a situation, such as a case where a facial photograph is to be printed, a case where a simple monochromatic logo is to be printed, a case where only a user name or a card number is to be printed, or a case where a special color is to be printed.

On the other hand, the state of the ink ribbon may be of any type, for example, a special color ink ribbon, a black-only ink ribbon, or a special color ink ribbon. In addition, the state of the ink ribbon may be information on an amount of the remaining ink ribbon, a state of a roll, the number of times printing is performed using a single ribbon (multi-time), a color position or the like.

The speed of printing may be selected according to whether to print at high speed or low speed, or the like.

Thereafter, the application execution section 100 sends the selected card printing setting data 300 to the driver execution section 110.

Here, a mode of the application execution section 100 may be switched by a command among a mode in which the card printing setting data 300 is transmitted to the card issuing device 2 every time (hereinafter referred to as an “every-time transmission mode”)), a mode in which data already stored in the printing section 23 of the card issuing device 2 may be used (hereinafter referred to as a “cache use mode”), and a mode in which only the prescribed data 320 is used (hereinafter referred to as a “prescribed mode”). The modes may be switched in accordance with a setting of the application or the like.

### Step S102

Next, the driver execution section 110 performs a data conversion transmission process.

The driver execution section 110 executes a device driver, middleware, or the like, so as to transmit the card printing setting data 300 selected by the application execution section 100 to the card issuing device 2. That is, in this embodiment, the card printing setting data 300 is not selected in the device driver, but is obtained directly from the application.

Specifically, the driver execution section 110 first notifies the card issuing device 2, by a parameter of a command, of information indicating that a mode in which a file transmitted from the host device 1 other than the prescribed file is to be used is entered. Then, the driver execution section 110 encodes (converts) the acquired card printing setting data 300 into the conversion data 310 that may be stored and used in a main body of the card issuing device 2.

Thereafter, the driver execution section 110 transmits the conversion data 310 obtained through the conversion as data accompanying the command to the card issuing device 2 by means of a USB or the like. In this case, the driver execution section 110 may first transmit a hash value, a checksum value, a file name, an ID, or the like (hereinafter simply referred to as a “hash value or the like”) of the conversion data 310.

### Step S201

Next, the common substrate 21 of the card issuing device 2 performs a data acquiring process as the setting acquirer.

Here, a controller of the common substrate 21 obtains the conversion data 310 from the host device 1. The controller of the common substrate 21 then decodes the conversion data 310 to be transmitted to the printing section 23.

### Step S202

Next, the printing section 23 determines whether the data has already been stored.

In this embodiment, when the previously acquired conversion data 310 stored in the recording medium of the printing section 23 is compatible with the card 4, the type of ink ribbon, and the like to be used in printing in a step below, the conversion data 310 may be continuously used for printing. Therefore, the printing section 23 determines whether the previously acquired conversion data 310 stored in the RAM, flash memory, or the like of the recording medium is the same as the conversion data 310 acquired from the host device 1 in step S201 described above. The determination may be made using the hash value described above or the like. When the data is the same, the printing section 23 makes an affirmative determination. Otherwise, the printing section 23 makes a negative determination. Note that the printing section 23 may make a negative determination also when the printing section 23 is in the every-time transmission mode as described above.

When the determination is affirmative, the printing section 23 advances the process to step S204. Accordingly, the already stored conversion data 310 (cache) may be used again.

When the determination is negative, the printing section 23 advances the process to step S203.

### Step S203

In a case where the conversion data 310 is different from the previously acquired conversion data 310 or in a case of the every-time transmission mode, the common substrate 21 and the printing section 23 perform an acquired data setting process.

The printing section 23 is set to store and use the data acquired from the host device 1 in the recording medium instead of the previously stored data. Therefore, when the common substrate 21 has not yet acquired the conversion data 310 other than the hash value or the like, the common substrate 21 acquires the conversion data 310 other than the hash value or the like from the host device 1 and transmits the conversion data 310 other than the hash value or the like to the printing section 23. The printing section 23 stores the conversion data 310 other than the hash value or the like in the recording medium.

### Step S204

Here, the printing section 23 performs a printing process.

The printing section 23 performs printing on the card 4 in accordance with a setting of the conversion data 310 of the acquired card printing setting data 300. Alternatively, the printing section 23 may perform printing on the card 4 in accordance with a setting of the previously acquired conversion data 310. Alternatively, the printing section 23 may perform printing in accordance with a setting of the prescribed data 320 when using the prescribed card 4 and the prescribed ink ribbon in the prescribed mode. In these cases, the strobe value or the like described above is reflected so that desired printing may be executed.

### Step S205

Next, the printing section 23 determines whether the printing has been successfully terminated.

When the printing has been successfully terminated, the printing section 23 makes an affirmative determination. When the printing has been abnormally terminated (an error), the printing section 23 makes a negative determination.

When the determination is affirmative, the printing section 23 advances the process to step S206.

When the determination is negative, the printing section 23 advances the process to step S207.

### Step S206

In a case of normal termination, the printing section 23 performs a normal termination notification process.

After the printing is terminated, the printing section 23 transmits a result of the printing to the host device 1 via the common substrate 21. Since the process is normally terminated, the normal termination is notified.

Thereafter, the printing section 23 terminates the card printing setting process.

### Step S207

In the case of abnormal termination, the printing section 23 performs an abnormal termination notification process.

After the printing is terminated, the printing section 23 notifies the host device 1 of the abnormal termination via the common substrate 21. At this time, the reason for the abnormal termination, such as lack of ribbon or wire breakage, may be notified to the host device 1.

The card printing setting process according to at least an embodiment of the present invention is thus terminated.

### Main Effects of This Embodiment

With the configuration described above, the following effects may be obtained.

In general, the printing section 23 of the card issuing device 2, such as that of Japanese Unexamined Patent Application Publication No. 2019-188708, stores printing setting data, such as a strobe value, which is the prescribed data 320, in a built-in recording medium. In this case, the storage capacity of the built-in recording medium is limited, and therefore, only one setting data may be stored and a plurality of setting data may not be stored.

However, the card issuing system X according to at least an embodiment of the present invention includes the card issuing device 2 that issues the card 4 and the host device 1 connected to the card issuing device 2. The host device 1 includes the application execution section 100 that selects card printing setting data corresponding to a state of the card issuing device 2, and a driver executor that transmits the card printing setting data 300 selected by the application execution section 100 to the card issuing device 2. The card issuing device 2 includes a setting acquirer that acquires the card printing setting data 300 from the host device 1, and a printing section 23 that performs printing on the cards 4 using the card printing setting data 300 acquired by the setting acquirer.

With this configuration, a setting for the desired card 4 and the desired consumables 3, such as an ink ribbon, may be selected from among the plurality of card printing setting data 300. Accordingly, printing may be appropriately performed using the various types of card 4 and various types of consumable 3. Furthermore, even when the card issuing device 2 does not include a recording medium for storing setting data individually corresponding to the types of card 4, the types of ink ribbon, and the like, printing may be appropriately performed suitable for the types of card 4, the types of ink ribbon, and the like. Furthermore, storing the prescribed data 320 in the printing section 23 also ensures compatibility.

In addition, since the printing setting data may be explicitly specified by the application instead of the device driver, the appropriate card printing setting data 300 intended by the application may be selected. Accordingly, printing may be performed on the card 4 with quality and an ink ribbon required by the application.

Furthermore, in recent years, supported types of ink ribbon have become more diverse, and a large number of setting data is required to be prepared. However, as described above, the recording capacity of the recording medium of the printing section 23 of the general card issuing device 2 is small, and furthermore, it is difficult to be cope with changes in the market.

On the other hand, in the card issuing system X according to at least the embodiment of the present invention, the card printing setting data 300 includes setting values for appropriately performing printing in accordance with a state of the consumables 3 for printing.

Specifically, in the card issuing system X of at least the embodiment of the present invention, the consumables 3 represents an ink ribbon for printing on the card 4, and the state of the card issuing device 2 includes at least one of a type of card 4 to be printed by the printing section 23 and a state of the ink ribbon attached to the printing section 23.

With this configuration, a plurality of card printing setting data 300 corresponding to the states of the consumables 3 are prepared in the host device 1, and one of the plurality of card printing setting data 300 is specified at a time of printing. In this way, the various states of the consumables are supported. Specifically, a variety of diversified ink ribbons may be supported. That is, even when a type of required ink ribbon changes due to market changes, etc., change in product design is not required. In other words, an overcoat ink ribbon, a black-only ink ribbon, a special color ink ribbon, and the like may be supported simply by preparing corresponding card printing setting data 300.

Furthermore, although only a color ink ribbon is used in the card issuing device 2 in general, a special color ink ribbon also come into use in recent years. However, when printing is performed using a card 4 or an ink ribbon that is not a target of the prescribed data 320, printing may not be performed with desired quality or at worst, the ink ribbon may break.

On the other hand, in the card issuing system X according to at least the embodiment of the present invention, the setting values include a strobe value, which is a value for a timing of activating the print head that performs printing using an ink ribbon.

With this configuration, printing may be performed with desired quality even when a special color ink ribbon is used.

### Other Embodiments

Note that, in the above-described embodiment, the case where the card printing setting data 300 is simply specified in the host device 1 is described as an example.

However, information on the consumables 3, such as the ink ribbon, of the card issuing device 2 may be acquired and the card printing setting data 300 corresponding to the information may be selected in the host device 1.

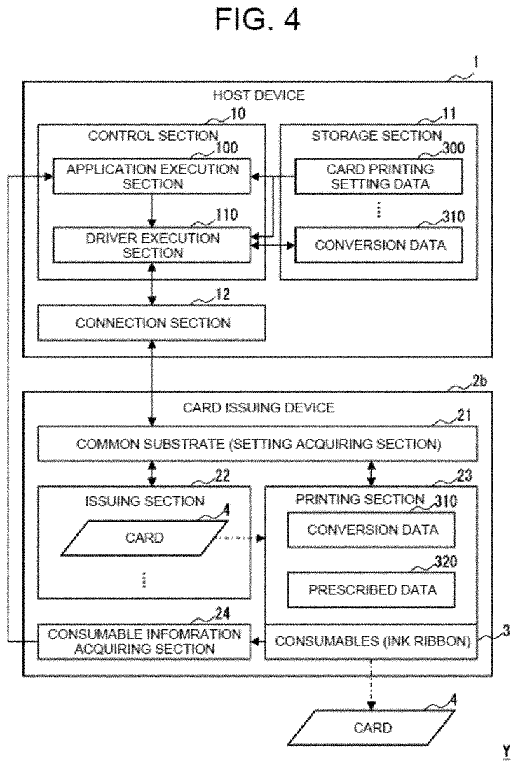

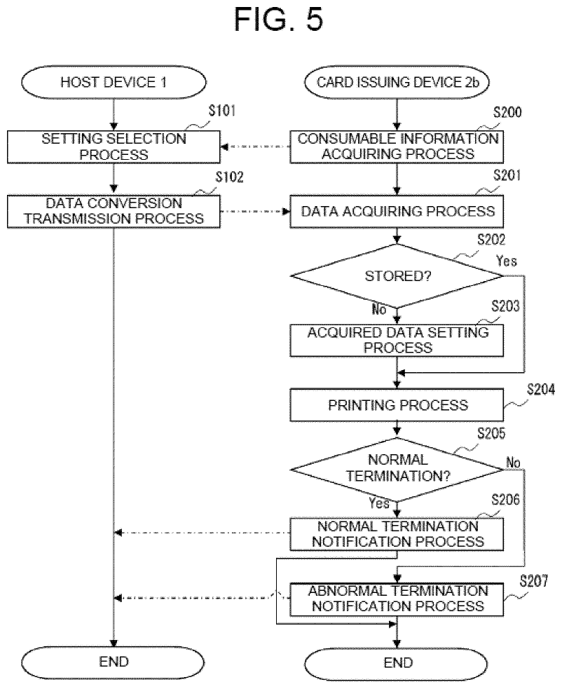

Specific examples of such a configuration will now be described with reference to FIGS. 4 and 5. Here, in FIGS. 4 and 5, components with the same signs as in FIGS. 1 and 2 indicate the same configurations and processes.

First, according to FIG. 4, in a card issuing system Y according to at least another embodiment of the present invention, a card issuing device 2b further includes a consumable information acquiring section 24 that acquires information on consumables 3, and an application execution section 100, based on the information on the consumables 3 acquired by the consumable information acquiring section 24, determines a state of the card issuing device 2b.

As shown in this figure, the consumables information acquiring section 24 acquires information on the consumables 3. Specifically, for example, when a ribbon cassette of an ink ribbon, which is the consumables 3, has a radio frequency identifier (RFID), the consumable information acquiring section 24 may be an RFID reader. In this case, the consumable information acquiring section 24 includes a radio frequency (RF) antenna for near field communication (NFC) or the like and a control IC.

According to FIG. 5, in step S200, the consumable information acquiring section 24 performs a consumable information acquiring process.

Here, the consumable information acquiring section 24 reads data on the RFID of a ribbon cassette as information on the consumables 3, and transmits the data to a host device 1. Note that this transmission may also be performed by sending and receiving commands via a common substrate 21.

Based on the information on the consumables 3, the application execution section 100 may determine a state of the card issuing device 2b and select appropriate card printing setting data 300. In this case, the card printing setting data 300 preferably includes information on a type of ink ribbon corresponding to the setting. Accordingly, the appropriate card printing setting data 300 corresponding to the ink ribbon installed in the printing section 23 may be automatically selected. The driver execution section 110 may then transmit the conversion data 310 based on the card printing setting data 300 to cause the card issuing device 2b to perform appropriate printing.

With this configuration, the appropriate card printing setting data 300 may be selected without bothering to specify the appropriate card printing setting data 300 in the application execution section 100. Specifically, the appropriate card printing setting data 300 corresponding to the ink ribbon installed in the printing section 23 may be specified and transmitted. Alternatively, when a consumable 3 that is different from that assumed by the application execution section 100 is installed, the application execution section 100 may select execution of printing corresponding to the consumable 3, notification to an administrator of an ATM, etc., or stop due to an error.

Note that electric waves of the RFID may be acquired even at a predetermined distance, and therefore, the consumable information acquiring section may be included in the host device 1.

With this configuration, the card printing setting data 300 may be automatically selected without changing the card issuing device 2.

Alternatively, a component other than the RFID reader may be used as the consumable information acquiring section 24. For example, a printing section 23 may include a reflection sensor described in Japanese Unexamined Patent Application Publication No. 2019-188708.

In this case, when printing is started, the ink ribbon is automatically wound up to a leading portion of a color of the ink ribbon. Specifically, in a case of a color ink ribbon, for example, the ribbon is set up to a portion of a yellow color. Similarly, in a case of a black-only ink ribbon or in cases of ink ribbons of other special colors, the ink ribbon is wound up to a portion of a set color. A value of the reflection sensor at this time may be acquired by the host device 1 as information on the consumables 3 to determine whether the ink ribbon is a color ink ribbon, a black-only ink ribbon, or a special color ink ribbon. Then, the card printing setting data 300 corresponding to the value of the reflection sensor may be selected.

With this configuration, appropriate card printing setting data 300 may be automatically set simply by providing the card printing setting data 300 corresponding to the value of the reflection sensor, thereby reducing the cost of the apparatus.

In the above-described embodiment, it is determined whether to transmit the conversion data 310 in accordance with a mode, such as the cache use mode or the every-time transmission mode set by the application execution section 100.

However, the card printing setting data 300 may be transmitted at other timings, such as a timing of an initial startup of the host device 1, a timing when a different application is executed, or a timing when the consumables 3 are changed or replaced. Alternatively, the conversion data 310 may be transmitted when a predetermined period of time has elapsed after a previous card issuance.

With this configuration, it is possible to flexibly cope with changes in types of various cards 4 and consumables 3 and the like.

Note that, in the above-described embodiment, the case where the conversion data 310 obtained by converting the card printing setting data 300 is transmitted to the card issuing device 2 or 2b is described as an example.

However, the card printing setting data 300 itself may be transmitted to the card issuing device 2 or 2b and stored in the recording medium of the printing section 23. Furthermore, the card printing setting data 300 and the conversion data 310 may not be merely encoded but may be encrypted with a common key, a public key, or the like before being transmitted to the card issuing device 2 or 2b.

With this configuration, various configurations may be supported. Furthermore, the encryption improves security.

In the above-described embodiment, the example is described in which the state of the card issuing device 2 represents the type of card 4 to be printed by the printing section 23 or the state of the ink ribbon attached to the printing section 23.

However, the card printing setting data 300 may be selected based on other states of the card issuing device 2. Specifically, for example, the card printing setting data 300 may be selected depending on a state of the print head, a state of a power supply voltage of the card issuing device 2, or a state of another consumable 3, such as a pad, a roller, or a heater, for printing.

With this configuration, the appropriate card printing setting data 300 may be selected depending on one of the various states of the card issuing device 2.

The printing section 23 of the card issuing device 2 may not be mounted on the card issuing device 2 but may be separately connected to the card issuing device 2 through a USB, wireless communication, or the like. Alternatively, the card issuing device 2 may not be connected to the host device 1 in a housing but may be connected to the host device 1, such as a PC or a smartphone, through a USB, wireless communication, or the like.

Furthermore, the card issuing device 2 may perform printing on a so-called “stand-alone” basis without being connected to the host device 1. In this case, the stand-alone card issuing device 2 may be temporarily connected to the host device 1 or a maintenance terminal to obtain the conversion data 310 described above.

In the above-described embodiment, the example is described in which the printing section 23 is a printer for cards using an ink ribbon.

However, the printing section 23 may be an inkjet printer, an electronic dry-photo printer, a laser-imprinted printer, a melting or UV-curing 3D printer, or the like. Even in such a case, at least an embodiment of the present invention may be applied to the consumables 3, such as an ink tank, a toner cassette, a filament, a resin tank, a print head, or the like.

With this configuration, various configurations may be flexibly supported.

In the above-described embodiment, the configuration relating to the issuance of cards 4 performed by the card issuing device 2 is mainly described.

However, the card issuing device 2 may include a function of a card reader including a head or the like to read information stored in the card 4. Examples of the head or the like include, for example, a magnetic head, a cryptographic magnetic head, an IC contact, and an electromagnetic induction antenna. In a case of the magnetic head, magnetic information recorded on a magnetic stripe provided on the card 4 may be read and written by the card 4 being contacted and slid. In a case of an IC contact, an electromagnetic induction antenna, or the like, information stored in an IC incorporated in the card 4 may be read and written by contact with a contact point of the card 4 or by electromagnetic induction, etc.

It is apparent that the configurations and the operations of the above embodiment are merely examples and may be modified and implemented as appropriate without departing from the scope of at least an embodiment of the present invention.

What is claimed is:

1. A card issuing system including a card issuing device that issues cards and a host device connected to the card issuing device,
the host device comprising:
an application executor to select card printing setting data corresponding to a state of the card issuing device; and
a driver executor to transmit the card printing setting data selected by the application executor to the card issuing device, and
the card issuing device comprising:
a setting acquirer to acquire the card printing setting data from the host device; and
a printer to perform printing on the cards using the card printing setting data acquired by the setting acquirer.

2. The card issuing system according to claim 1, wherein the card printing setting data includes a setting value for appropriate printing based on a state of consumables for printing.

3. The card issuing system according to claim 2, wherein
the consumables represent an ink ribbon for printing on the cards, and
a state of the card issuing device includes at least a type of the cards to be printed by the printer or a state of the ink ribbon mounted on the printer.

4. The card issuing system according to claim 3, wherein the setting value includes a strobe value that is a value of a timing when a print head used for printing using the ink ribbon is operated.

5. The card issuing system according to claim 2, wherein
the card issuing device further includes a consumable information acquirer that acquires information on the consumables, and
the application executor determines a state of the card issuing device based on the information on the consumables acquired by the consumable information acquirer.

6. A card issuing method executed by a card issuing system including a card issuing device that issues cards and a host device connected to the card issuing device, the card issuing method comprising:
selecting, by the host device, card printing setting data corresponding to a state of the card issuing device;
transmitting, by the host device, the selected card printing setting data to the card issuing device;
acquiring, by the card issuing device, the card printing setting data from the host device; and
performing, by the card issuing device, printing on the cards using the acquired card printing setting data.

7. The card issuing system according to claim 3, wherein
the card issuing device further includes a consumable information acquirer that acquires information on the consumables, and
the application executor determines a state of the card issuing device based on the information on the consumables acquired by the consumable information acquirer.

8. The card issuing system according to claim 4, wherein
the card issuing device further includes a consumable information acquirer that acquires information on the consumables, and
the application executor determines a state of the card issuing device based on the information on the consumables acquired by the consumable information acquirer.
